(19) United States
(12) Patent Application Publication
(10) Pub. No.: US 2026/0358109 A1
(43) Pub. Date: Nov. 12, 2026

(54) ROLLING ELEMENT, USE AND ARRANGEMENT THEREOF

(71) Applicant: ROCKROTH OY, Sipoo (FI)

(72) Inventor: Andreas STENROTH, Sipoo (FI)

(21) Appl. No.: 19/129,906

(22) PCT Filed: Nov. 16, 2023
(86) PCT No.: PCT/EP2023/082073

§ 371 Date: May 14, 2025

(30) Foreign Application Priority Data
Nov. 16, 2022 (FI) 20227146

(51) Int. Cl. G01B 3/12; G01B 1/00; G01B 5/04

(52) U.S. Cl. CPC G01B 3/12; G01B 1/00; G01B 5/043

(57) ABSTRACT

A rolling element suitable for measuring distance on a surface of a workpiece includes an elongated cylindrical body made from cold-work tool steel, the coldwork tool steel including carbides that have average carbide sizes of at least 15 micrometers in a direction, and a carbide volume fraction of at least 9%. The elongated cylindrical body is further hardening processed. A measuring tool utilizing such rolling element is also disclosed.

### FIELD OF THE INVENTION

Generally the present invention relates to measuring equipment. In particular, however not exclusively the present invention pertains to devices used for measuring distances on a surface of a workpiece.

### BACKGROUND

Rolling components for measuring equipment have been discussed in prior art. For example, European patent publication EP3264025 B1 discloses a measuring device having a ring type body with teeth along the surface of the body. Similar solutions are also known having wheel type constructions. Also, elongated cylindrical bodies that can be used as rollers are known from the context of conveyors, which are however not used for precision distance measurement.

### SUMMARY OF THE INVENTION

The objective is to at least alleviate or at least alleviate or mitigate, at least some of the problems described hereinabove not satisfactorily solved by the known arrangements.

The present disclosure is especially beneficial to be used in linear precision measurement wherein the size of the roller needs to be small. With smaller dimensions it is crucial that the shape of the body of the roller is precise and that the body can withhold abrasive wear since changes in small dimensions can cause big changes in measuring precision relative to the size of the equipment.

A further advantage of the present disclosure is that it allows for accuracy that is sufficient in regards to relevant workpiece measuring and machining standards for a wide range of measured distances. This is an important advantage when working with e.g. elongated workpieces such as beams and girders that may require both small distance and longer distance measurements wherein the accuracy of those measurements should stay in the tolerances set by relevant standards.

The aforesaid objectives are achieved by the embodiments of a device in accordance with the present disclosure.

Accordingly, in one aspect of the present disclosure a rolling element usable for measuring a distance on a surface of workpiece, the rolling element comprising
an elongated cylindrical body said body comprising cold-work tool steel, said cold-work tool steel comprising
   carbides that have average carbide sizes of at least 15 micrometres in a direction,
   carbide volume fraction of at least 9%,
said elongated cylindrical body further being hardening processed.

In accordance with one embodiment of the present disclosure the cylindrical body has a smooth rolling surface.

In accordance with one embodiment of the present disclosure the cylindrical body has a cylindricity of 0,003.

In accordance with one embodiment of the present disclosure the cylindrical body has an outer diameter of 70-100 millimeters.

In accordance with one embodiment of the present disclosure the cylindrical body has a length of 40-60 millimeters.

In accordance with one embodiment of the present disclosure the carbides are chromium carbides.

In accordance with one embodiment of the present disclosure the cylindrical body comprises at least one hollow portion.

In accordance with one embodiment of the present disclosure the cylindrical body comprises a plurality of hollow portions in a revolver cylinder shape.

In accordance with a further aspect of the present disclosure use of rolling element of claim 1 in a measuring tool.

In accordance with a further aspect of the present disclosure an arrangement for a measuring tool comprising,
a rolling element usable for measuring a distance on a surface of workpiece, the rolling element comprising
   an elongated cylindrical body said body comprising cold-work tool steel, said cold-work tool steel comprising
      carbides that have average carbide sizes of at least 15 micrometres in a direction,
      carbide volume fraction of at least 9%,
   said elongated cylindrical body further being hardening processed; and
sensing means coupled to the rolling element to measure the rotation of the rolling element, and means to translate said measured rotation into distance travelled along an outer surface of the rolling element.

The utility of the present invention follows from a plurality of factors depending on each particular embodiment.

The expression “a number of” refers herein to any positive integer starting from one (1), e.g. to one, two, or three.

The expression “a plurality of” refers herein to any positive integer starting from two (2), e.g. to two, three, or four.

Different embodiments of the present invention are disclosed in the dependent claims.

### BRIEF DESCRIPTION OF THE RELATED DRAWINGS

Next the invention is described in more detail with reference to the appended drawings in which

FIG. 1 illustrates a general view of an embodiment of the rolling element in accordance with the present disclosure,

FIG. 2 illustrates a general view of another embodiment of the rolling element in accordance with the present disclosure,

FIG. 3 illustrates a side view of an embodiment of the rolling element, positioned against a workpiece, in accordance with the present disclosure, and

FIG. 4 illustrates a side view of an embodiment of the rolling element, positioned against another workpiece, in accordance with the present disclosure.

### DETAILED DESCRIPTION OF THE EMBODIMENTS

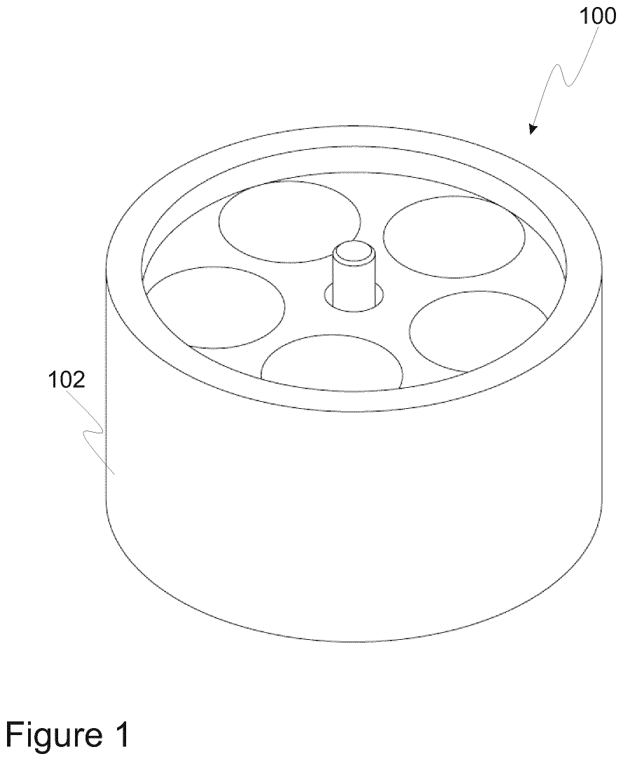

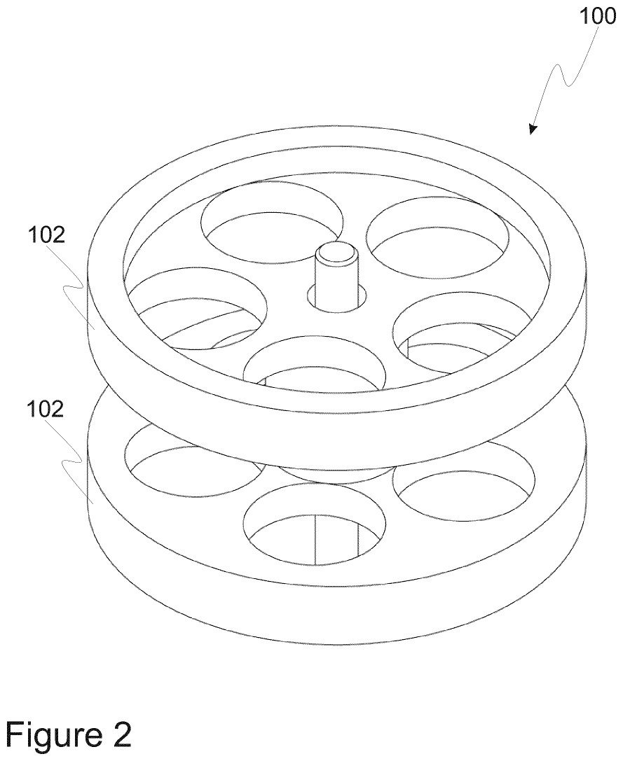

Referring to FIGS. 1-2, some embodiments of the rolling element (100) are illustrated. The rolling element (100) is usable for measuring at least distance on and along a surface of workpiece. The rolling element (100) comprises at least an elongated cylindrical body. Preferably the elongated cylindrical body has a smooth rolling surface (102) as the outer surface. Alternatively or additionally, the elongated cylindrical body may have a number of shapes or grooves on the surface, which may be used to improve friction characteristics, and/or to deter and/or direct dirt away from the surface and/or rolling portion of the surface.

FIG. 1 illustrates an example of an embodiment of the rolling element (100) having a plurality of hollow portions along the length of the body. In this embodiment the hollow portions are in a revolver cylinder shape.

FIG. 2. illustrates an example of an embodiment of the rolling element (100) having a plurality of hollow portions along the length of the body and a body having a cylindrical shape with a cutout around the body. As illustrated, the outer surface (102) of the rolling element (100) body does not need to be uniform although it needs to have a physical or virtual shape wherein one or more surface portions define a cylindrical body shape said one or more surface portions also defining the rolling surface (102) of the rolling element (100).

The elongated cylindrical body of the rolling element (100) comprises cold-work tool steel, which cold-work tool steel comprises carbides that have average carbide sizes of at least 15 micrometres in a direction, and a carbide volume fraction of at least 9%. Average carbide size is commonly measured in both longitudinal and transverse directions but for the present disclosure it is sufficient that at least either of these average sizes is at least 15 micrometres. An example for the carbide volume fraction range is 9-20%. These carbides are preferably chromium carbides although other types of carbides may also be used. The elongated body is further hardening processed. These material and manufacturing parameters effectively give the body a sufficient hardness for precision measurement and resistance to mechanical wear. However, a person skilled in the art will understand a higher average carbide size and carbide volume fraction are also possible and may yield different although feasible embodiments of the present disclosure.

The rolling element (100) is preferably small in scale, and some examples of rolling surface (102) outer diameter are in the range of 70-100 millimeters. An advantageous example of cylindricity tolerance is 0.003, which provides the rolling element (100) a good accuracy for precision-measuring. However, other diameters are also feasible and can be selected in view of design parameters of the intended use of the rolling element (100).

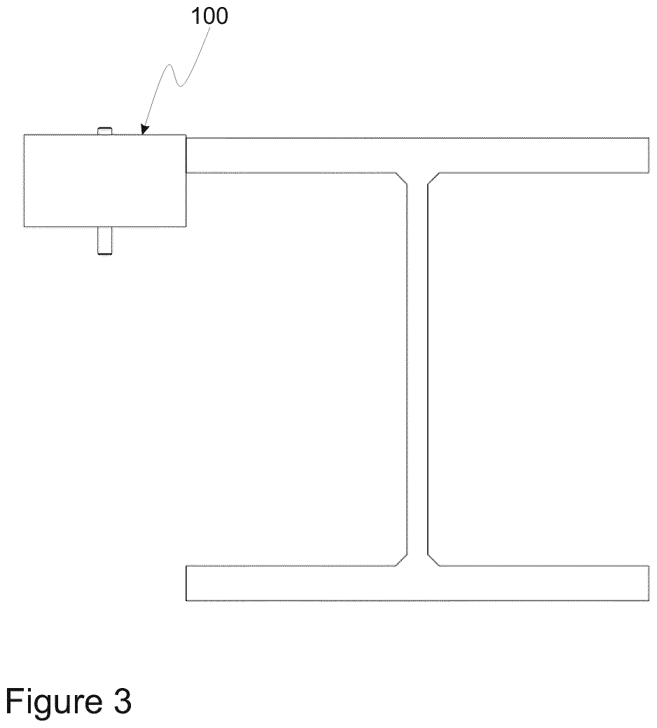

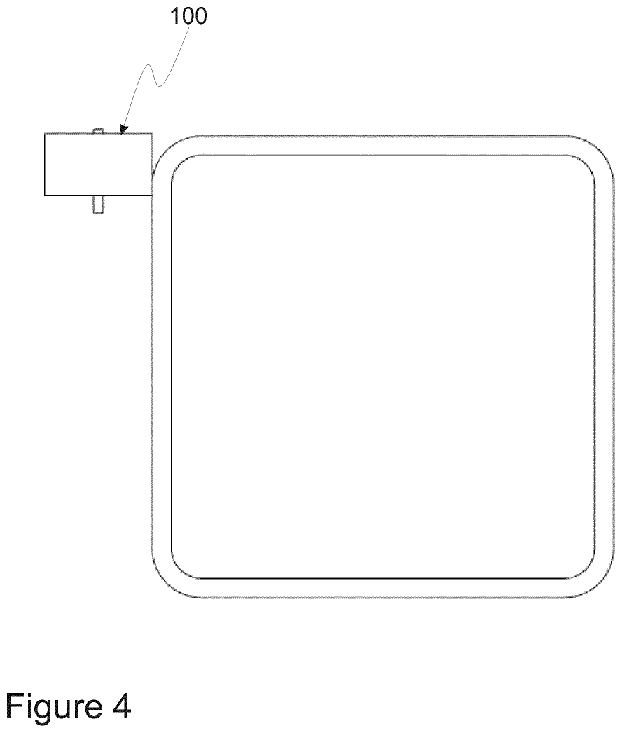

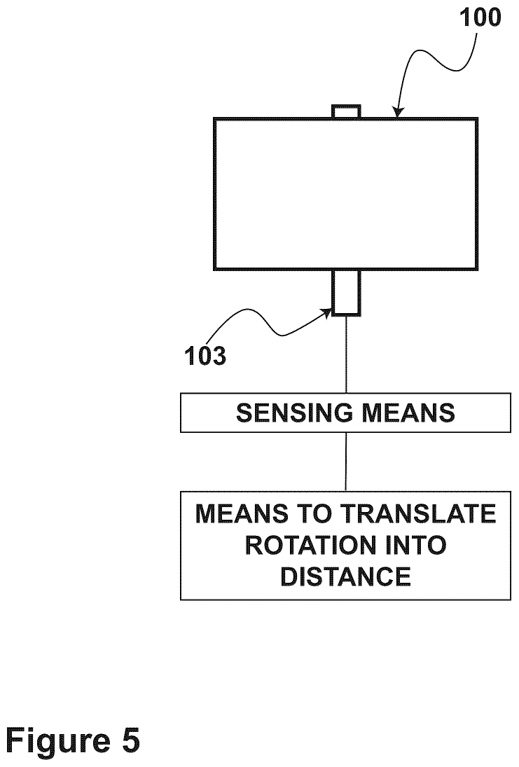

FIGS. 3-4 illustrate the principle of the rolling element (100) shown together with a workpiece, such as a bar or I-beam or H-beam.

The rolling element (100) is preferably used in a measuring tool. An embodiment of an arrangement for a measuring tool may comprise the rolling element (100) coupled with sensing means to measure the rotation of the rolling element (100), and means to translate said measured rotation (or revolution) into distance travelled along an outer surface of the rolling element (100). Various different types of incremental encoders or rotary encoders may be used to detect rotation of the rolling element (100). For example, such sensing means may be arranged at an axle running through the rolling element (100), which axle may be connected to a larger tool, frame or such, constituting a measurement device utilizing the rolling element (100) for measuring linear distance from the rolling and revolution thereof of the rolling element (100). The sensing means may comprise or be connected with a processing circuit or processing entity, which may translate signals from these sensing means into distance measurement and further optionally provide these to a user for reading the distance measurement.

Consequently, a skilled person may on the basis of this disclosure and general knowledge apply the provided teachings in order to implement the scope of the present invention as defined by the appended claims in each particular use case with necessary modifications, deletions, and additions.

1. A rolling element usable for measuring of distance on a surface of a workpiece, the rolling element comprising:
an elongated cylindrical body, said body comprising cold-work tool steel, said cold-work tool steel comprising:
carbides that have average carbide sizes of at least 15 micrometers in a direction, and
a carbide volume fraction of at least 9%,
said elongated cylindrical body further being hardening processed.

2. The rolling element of claim 1, wherein the elongated cylindrical body has a smooth rolling surface.

3. The rolling element of claim 1, wherein the elongated cylindrical body has a cylindricity tolerance of 0.003.

4. The rolling element of claim 1, wherein the elongated cylindrical body has an outer diameter of 70-100 millimeters.

5. The rolling element of claim 1, wherein the elongated cylindrical body has a length of 40-60 millimeters.

6. The rolling element of claim 1, wherein the carbides are chromium carbides.

7. The rolling element of claim 1, wherein the elongated cylindrical body comprises at least one hollow portion.

8. The rolling element of claim 1, wherein the elongated cylindrical body comprises a plurality of hollow portions.

9. (canceled)

10. A measuring tool, comprising:
a rolling element configured to measure a distance on a surface of workpiece, the rolling element comprising:
an elongated cylindrical body, said body comprising cold-work tool steel, said cold-work tool steel comprising:
carbides that have average carbide sizes of at least 15 micrometers in a direction, and
a carbide volume fraction of at least 9%,
said elongated cylindrical body further being hardening processed; and
a sensor coupled to the rolling element and configured to measure rotation of the rolling element; and
a converter configured to translate said measured rotation into distance travelled along an outer surface of the rolling element.
